(19) United States
(12) Patent Application Publication
(10) Pub. No.: US 2022/0099439 A1
(43) Pub. Date: Mar. 31, 2022

(54) RANGEFINDER WITH AUTOMATIC OPENING AND CLOSING AND DETECTION

(71) Applicant: TUNG SHRIM ENTERPRISE CO., LTD., Taichung City (TW)

(72) Inventor: WEN-I CHANG, Taichung City (TW)

(21) Appl. No.: 17/033,953

(22) Filed: Sep. 28, 2020

(51) Int. Cl. G01C 3/08; G01S 17/86

(52) U.S. Cl. CPC G01C 3/08; G01C 3/04; G01S 17/86

(57) ABSTRACT

A rangefinder with automatic opening and closing and detection includes: a detection module, including a laser transmitter and laser receiver, the laser transmitter emitting laser light to a measured object, and the laser receiver receiving reflected laser light reflected by the measured object; an objective lens, receiving invisible light reflected by the measured object; an image sensing device, receiving the invisible light and generating an image signal; a display device, displaying an image of the measured object captured by the image sensing device; an eyepiece, allowing the display device to be viewed therethrough; and at least one multi-axis sensor, the detection module, image sensing device and display device being activated when the multi-axis sensor detects that the rangefinder is lifted up, and the detection module, image sensing device and display device being turned off when the multi-axis sensor detects that the rangefinder is lowered down.

### (a) TECHNICAL FIELD OF THE INVENTION

The present invention relates to a distance measuring device, and more particularly to a rangefinder with multiple sensors, capable of automatic opening and closing and distance measurement.

### (b) DESCRIPTION OF THE PRIOR ART

The rules of golf mainly require players to use the least number of strokes to hit the ball into the target (i.e. green) hole from the tee, and the two big basic factors existing between the tee and target hole are “distance” and “angle” (of course, there are still other factors such as wind speed and turf trend, which will not be discussed here). In addition to controlling the ball direction with their swing skills, the most important thing for contestants is to accurately measure the distance to the target with their experience in order to control the distance of the hitting ball. For beginners in golf, the most important is that they must learn how to accurately measure the distant between the target and the location besides they must constantly practice swing shots to improve ball control and swing strength if they want to improve their golf skills.

Conventional distance measuring devices used in the above-mentioned distance measurement have the disadvantage that they only can detect the distance of one single target. For users, they need to measure several times if the distances to other targets want to be detected, which is not convenient enough. In addition, it is still necessary to record the distance data of each target with pen and paper.

All rangefinders on the market now can be started only by pressing a button or switch whether they are rangefinders that measure a single target or rangefinders that measure multiple targets. After the rangefinder is started by pressing, every distance can be measured still by pressing the rangefinder once more, which is not intuitive, instant, and convenient in use, and may cause shaking when the switch is pressed.

### SUMMARY OF THE INVENTION

To overcome the disadvantages mentioned above, the present invention proposes a rangefinder with automatic opening and closing and detection, including: a detection module, including a laser transmitter and laser receiver, the laser transmitter emitting laser light to a measured object, and the laser receiver receiving reflected laser light reflected by the measured object, wherein an optical path of the laser light is formed by the laser transmitter and laser receiver; an objective lens, receiving invisible light reflected by the measured object; an image sensing device, receiving the invisible light captured by the objective lens and generating an image signal; a display device, displaying an image of the measured object captured by the image sensing device, wherein an optical path of the invisible light includes the object lens, image sensing device and display device; an eyepiece, configured beside the display device, allowing the display device to be viewed through the eyepiece; and at least one multi-axis sensor, in electric connection with the detection module, image sensing device and display device, the detection module, image sensing device and display device being activated when the multi-axis sensor detects a vertical up-down displacement of 0 degrees to 180 degrees of the rangefinder, and the detection module, image sensing device and display device being turned off when the multi-axis sensor detects a vertical up-down displacement of 180 degrees to 0 degrees of the rangefinder.

### BRIEF DESCRIPTION OF THE DRAWINGS

FIGS. 1 and 2 respectively are a perspective view of the present invention; and

FIG. 3 shows an operation state of the present invention.

### DETAILED DESCRIPTION OF THE PREFERRED EMBODIMENTS

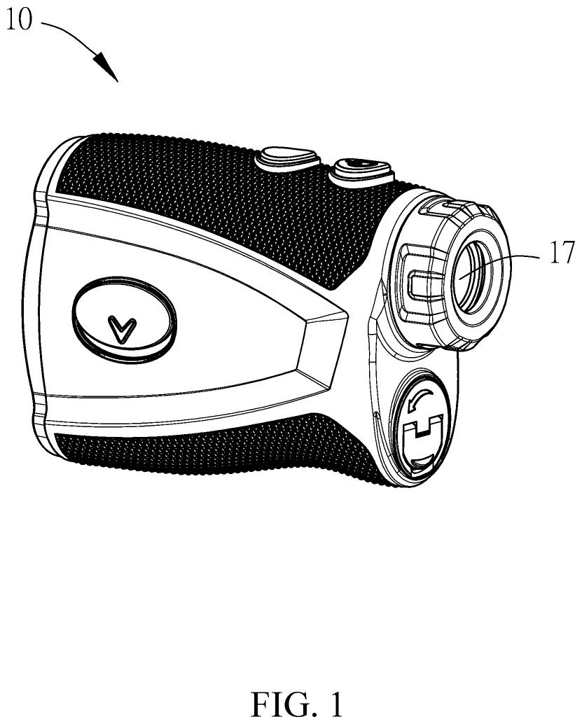

Referring to FIGS. 1 to 3, a rangefinder 10 with automatic opening and closing and detection of the present invention includes a detection module A including a laser transmitter 11, laser receiver 12, objective lens 13, autofocus lens 14, image sensing device 15, display device 16, eyepiece 17, and multi-axis sensor 20.

The detection module A further includes a collimating lens 18 and collecting lens 19, thereby forming a laser transmitting and receiving system for the rangefinder 10 with automatic opening and closing and detection of the present invention.

The objective lens 13, autofocus lens 14 and image sensing device 15 are formed into an image capturing system for the rangefinder 10 with automatic opening and closing and detection.

The display device 16 and eyepiece 17 are formed into a display system for the rangefinder with automatic opening and closing and detection.

The multi-axis sensor 20 is in electric with the detection module, image sensing device 15 and display device 16. When the multi-axis sensor 20 detects a vertical up-down displacement of 0 degrees to 180 degrees, the detection module, image sensing device 15 and display device 16 are activated; when the multi-axis sensor 20 detects a vertical up-down displacement of 180 degrees to 0 degrees, the detection module, image sensing device 15 and display device 16 are turned off, where the multi-axis sensor 20 is a 3-axis, 6-axis or 9-axis sensor.

In another word, when the multi-axis sensor 20 senses that a user's hand lifts the rangefinder 10 of the present invention, the physical action of lifting it any angle in the range of 0 degrees to 180 degrees will cause the multi-axis sensor 20 to be activated immediately. At this time, the multi-axis sensor 20 does not need to press any switch any more, a distance can be accurately measured any time; when the rangefinder 10 is aimed at any target, the distance will be automatically displayed, and there is no need to press any button at all.

When the distance measurement is completed, the multi-axis 20 will sense that the user lowers down the rangefinder 10 of the present invention; the physical action of lowering it any angle in the range of 180 degrees to 0 degrees will cause the multi-axis sensor 20 to be turned off immediately.

With the above structure, the rangefinder 10 with automatic opening and closing and detection of the present invention has the following advantage over the prior arts:

1. the present invention completely eliminates the inconvenience that the user must press a button to open the rangefinder, and completely eliminates the inconvenience that the user must press a button to measure the distance, shortening the time for the user to start the rangefinder, and also shorten the time for the user to measure the distance; and

2. when the distance is measured, the present invention also eliminates the shaking caused from button pressing, increases the accuracy of the distance measurement, reduces measurement time, and improves the operation convenience of the distance measurement of the rangefinder.

When in use, the rangefinder 10 is directed to a measured area (not shown in the figures), and invisible light V10 will be radiated from the measured area to the rangefinder 10; the invisible light image of the measured area can be captured after the invisible light V10 is received by the image sensing device 15, and the invisible light image of the measured area is then transmitted to the display device 16 for a user to view; and the user aims the rangefinder 10 at one of measure objects (not shown in the figures) according to the invisible light image of the viewed measured area. Thereafter, the laser transmitting and receiving system sends laser light 181 to the measured object, and receives reflected laser light 191 reflected by the measured object. After the subsequent data processing, the measured object distance is transmitted to the display system for the user to view.

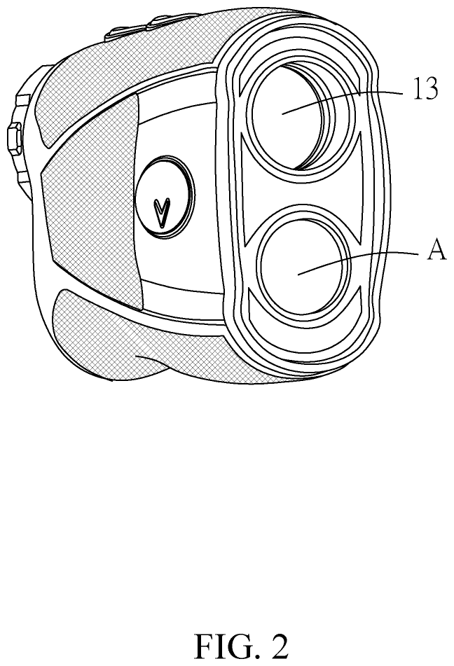

The optical path of the invisible light during use will be explained below. The rangefinder 10, as FIG. 2 shows, is directed to the measured area (not shown in the figure) during use, the invisible light V10 will be radiated from the measured area to the rangefinder 10; the invisible light V10 is first passed through the objective lens 13, then radiated into the autofocus lens 14, and finally arrives at the image sensing device 14; the image sensing device 14 receives the invisible light from the measured area, and then converts the optical image of the measured area to an image signal; the image signal is then output to the display device 16, the eyepiece 17 configured beside the display device 16 allows a user's eyes to view the measured area image presented on the display device 16 through the eyepiece 17.

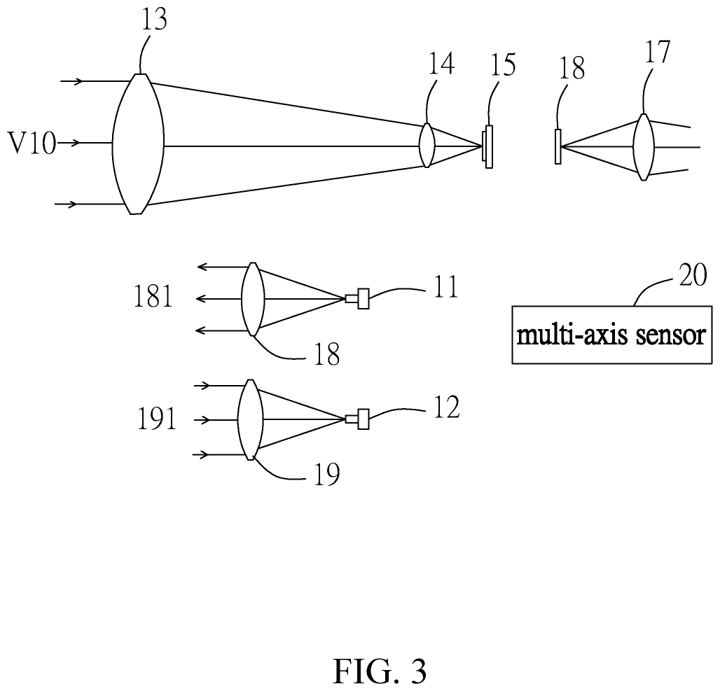

The optical path of the laser light during use will be described below. the rangefinder 10, as FIG. 3 shows, is adjusted to accurately aim at the measured object (not shown in the figure) in the measured area, and the laser transmitter 11 emits the laser light 181; the laser light 181 is first passed through the collimating lens 18, and the collimating lens 18 can turn the laser light 181 originally diverging outward into collimated laser light 181 and then radiated towards the measured object; the measured object can reflect the laser light 181, allowing reflected laser light 191 to be radiated toward the rangefinder 10; the reflected laser light 191 radiated toward rangefinder 10 is first passed through the collecting lens 19 and then radiated into the laser receiver 12, and the measured object distance is displayed on the display device 16 through subsequent data processing, and the user then uses the eyepiece 17 to view the measured object distance data displayed by the display device 16 after the laser receiver 12 receives the reflected laser light 191.

In the above embodiment, the reflected laser light 191 is directly radiated into the laser receiver 12. However, it can be understood that if a filter plate is placed between the collecting lens 19 and laser receiver 12, the filter plate only allows the reflected lase light 191 to be passed through, which should also drop in the scope of the present invention.

In the above embodiment, the laser transmitter 11 may be a semiconductor laser transmitter, and laser receiver 12 an avalanche photodiode (APD) or photodiode (PD). The image sensing device 14 may be a charge coupled device (CCD) or complementary metal oxide semiconductor (CMOS) image sensing element. The display device 16 may be a liquid crystal display (LCD), organic light emitting diode (OLED) or active matrix organic light emitting diode (AMOLED).

I claim:

1. A rangefinder with automatic opening and closing and detection, comprising:
a detection module, comprising a laser transmitter and laser receiver, said laser transmitter emitting laser light to a measured object, and said laser receiver receiving reflected laser light reflected by said measured object, wherein an optical path of said laser light is formed by said laser transmitter and laser receiver;
an objective lens, receiving invisible light reflected by said measured object;
an image sensing device, receiving said invisible light captured by said objective lens and generating an image signal;
a display device, displaying an image of said measured object captured by said image sensing device, wherein an optical path of said invisible light comprises said object lens, image sensing device and display device;
an eyepiece, configured beside said display device, allowing said display device to be viewed through said eyepiece; and
at least one multi-axis sensor, in electric connection with said detection module, image sensing device and display device, said detection module, image sensing device and display device being activated when said multi-axis sensor detects a vertical up-down displacement of 0 degrees to 180 degrees of said rangefinder, and said detection module, image sensing device and display device being turned off when said multi-axis sensor detects a vertical up-down displacement of 180 degrees to 0 degrees of said rangefinder.

2. The rangefinder according to claim 1, wherein said multi-axis sensor is a 3-axis, 6-axis or 9-axis sensor.
